(19) United States
(12) Patent Application Publication
(10) Pub. No.: US 2014/0008971 A1
(43) Pub. Date: Jan. 9, 2014

(54) Three-phase induction machine and method for operating a three-phase induction machine in an aircraft or spacecraft

(71) Applicant: Lars Hoffmann, Stuhr (DE)

(72) Inventor: Lars Hoffmann, Stuhr (DE)

(73) Assignee: AIRBUS OPERATIONS GMBH, Hamburg (DE)

(21) Appl. No.: 13/989,206

(22) PCT Filed: Nov. 9, 2011
(86) PCT No.: PCT/EP2011/069731

§ 371 Date: Sep. 16, 2013

Related U.S. Application Data
(60) Provisional application No. 61/417,524, filed on Nov. 29, 2010.

(30) Foreign Application Priority Data
Nov. 26, 2010 (DE) 10 2010 062 060.2

(51) Int. Cl. H02K 3/28

(52) U.S. Cl. CPC H02K 3/28
USPC 307/9.1; 310/68 R; 318/766

(57) ABSTRACT

A three-phase induction machine with a starting winding and a running winding and a winding change-over switch which switches over a flow of current between the starting winding and the running winding, wherein a phase of the phases of the starting winding and a corresponding phase of the phases of the running winding of the three-phase induction machine are supplied with electrical energy by a common electrical supply line, and wherein one phase of the phases of the starting winding and the corresponding phase of the phases of the running winding are electrically interconnected by an electrically conductive connection in the three-phase induction machine. Also provided is a method for operating a three-phase induction machine as well as an aircraft or spacecraft which has a corresponding three-phase induction machine.

### CROSS-REFERENCES TO RELATED APPLICATIONS

This application claims the benefit of the U.S. Provisional Application No. 61/417,524, filed on Nov. 29, 2010, and of the German patent application No. 10 2010 062 060.2 filed on Nov. 26, 2010, the entire disclosures of which are incorporated herein by way of reference.

### FIELD OF THE INVENTION

The present invention relates to a three-phase induction machine, in particular to a three-phase induction machine for use in an aircraft or spacecraft, and to a method for operating a three-phase induction machine and to an aircraft or spacecraft having a corresponding three-phase induction machine

### BACKGROUND OF THE INVENTION

Three-phase induction machines are electrical machines which can be used as motors. Compared to other electric drives, three-phase induction machines have the advantage that they are simple to construct and thus have a robust construction method. Furthermore, three-phase induction machines are self-starting. This means that no electronics or circuitry is required in order to be able to operate a three-phase induction machine. In the simplest case, a three-phase induction machine can be directly connected to a three-phase supply for its operation.

Three-phase induction machines are usually produced as electric drives with an output of up to several megawatts. Three-phase induction machines are used in particular as drives for actuators in aircraft or spacecraft or in aeroplanes, for example, for hydraulic or pneumatic pumps/compressors.

A challenge arising from the use of three-phase induction machines is the high starting current of such machines If this starting current is not known, it is assumed that it is eight times the nominal current of the three-phase induction machine concerned. Particularly in the case of high-powered three-phase induction machines, this can result in impairment or even disruption of the three-phase supply to which the respective three-phase induction machine is connected. Therefore, in spite of the self-starting characteristics of three-phase induction machines, different devices and/or methods are used to reduce or restrict the starting current of a three-phase induction machine

One possibility for reducing the starting current of a three-phase induction machine is, for example, to use a starting transformer. This starting transformer reduces the voltage at which the three-phase induction machine is operated, and thus the starting current and the load of the mains is also reduced. However, the mechanical moment applied by the three-phase induction machine during the start-up phase is also reduced.

Another possibility for reducing the starting current of a three-phase induction machine is to use electronic starting methods. Specific soft-start devices or starting converters are available for this purpose.

FIG. 7 shows a schematic illustration of a conventional three-phase induction machine A.

In FIG. 7, reference numeral A identifies a three-phase induction machine comprising a motor winding B and a starting converter C. The three phases Ph 1, Ph 2, Ph 3 of the motor winding B are coupled with the starting converter C by the lines D1, D2, D3. The starting converter C generates at the three phases Ph 1, Ph 2, Ph 3 of the motor winding B a voltage pattern which slowly increases the switching frequency, starting from a frequency of zero Hz, up to the nominal frequency of a three-phase supply E. The starting converter thereby minimises the load of the three-phase supply E and ensures a high starting torque.

The circuit arrangement shown in FIG. 7 which is configured to reduce the starting current of the three-phase induction machine A, suffers from the disadvantage that a complex wiring of the three-phase induction machine A is required and/or control electronics have to be provided. This increases the complexity of the installation and thus also increases the cost of using a three-phase induction machine A.

### SUMMARY OF THE INVENTION

Therefore, one idea of the present invention is to reduce the wiring complexity for reducing the starting current of a three-phase induction machine

The present invention provides a three-phase induction machine comprising a starting winding, a running winding and a winding change-over switch which switches over a flow of current between the starting winding and the running winding, a phase of the various phases of the starting winding and a corresponding phase of the various phases of the running winding of the three-phase induction machine being supplied with electrical energy by a common electrical supply line and the one phase of the various phases of the starting winding and the corresponding phase of the various phases of the running winding in the three-phase induction machine being electrically interconnected by an electrically conductive connection.

Furthermore, the present invention provides a method for operating a three-phase induction machine, in particular a three-phase induction machine according to the invention, the method comprising the steps of: supplying a phase of a starting winding and a corresponding phase of a running winding of the three-phase induction machine with electrical energy by a common electrical supply line, generating at least one switch signal by a control device depending on whether the starting winding or the running winding of the three-phase induction machine is to be supplied with electrical energy, supplying the starting winding with electrical energy and/or the running winding with electrical energy subject to the at least one switch signal generated by the control device.

Finally, the invention provides an aircraft or spacecraft which has a three-phase induction machine according to the invention and a three-phase supply.

The understanding on which the present invention is based is that in a three-phase induction machine comprising a starting winding and a running winding, a first disconnected winding, for example the starting winding is ineffective. A voltage induced in the first winding from the second winding which is in operation, for example the running winding, also has no influence on the efficiency of the three-phase induction machine, because current cannot flow in the first disconnected winding. Furthermore, this also applies if, in a three-phase induction machine, only two phases of the first disconnected winding are opened or disconnected.

The idea on which the present invention is based is to disconnect or switch over as usual the supply of electrical energy of two of the three phases of the starting winding and two of the three phases of the running winding, but to supply a third phase of the starting winding and a third phase of the running winding with electrical energy by a common electrical supply line. Since a current can only flow in the winding in which more than one phase is connected to the three-phase supply, it is furthermore possible, even with a jointly connected phase in the starting winding and in the running winding, to completely disconnect one of the windings. In this case, the second winding can be operated as if it were connected to the three-phase supply separately from the first winding.

An advantage of the invention is based on the fact that in a three-phase induction machine configured thus, one phase of the starting winding and one phase of the running winding can be supplied in each case with electrical energy starting from a common electrical supply line.

Due to the omission of one electrical supply line, it is thus possible to achieve a reduction in complexity and weight, particularly in arrangements with a spatial separation of winding change-over switch and of the starting and running windings. The weight reduction is particularly advantageous in mobile uses, for example in an aircraft or spacecraft or aeroplane, since fuel can be saved.

Furthermore, the omission of one electrical supply line means that the likelihood of an insulation error or of an interruption in the line supplying the starting and running windings of the three-phase induction machine is reduced.

Finally, due to the omission of one electrical line in each connecting element, for example in a plug or a socket, it is possible to dispense with one electrical contact.

Advantageous embodiments and improvements of the invention are provided in the subclaims.

According to a possible embodiment, the winding change-over switch comprises a change-over switch which is configured to switch over with a three-phase supply an electrical connection between in each case two phases, supplied separately with electrical energy, of the phases of the starting winding and the two respectively corresponding phases, supplied separately with electrical energy, of the phases of the running winding, and comprises a control device which is configured to generate a switch signal for the change-over switch, the winding change-over switch permanently connecting to the three-phase supply an electrical supply line for the phases of the starting winding and the running winding which are electrically interconnected. If only one change-over switch is used in the winding change-over switch which supplies two phases of the starting winding or two phases of the running winding with electrical energy respectively in an alternating manner, it is possible to provide a simple winding change-over switch which always supplies one of the two windings with electrical energy. A winding change-over switch of this type is not complex and is simple to produce.

According to a further possible embodiment, the winding change-over switch has a first switch which is configured to produce and/or to disconnect an electrical connection between in each case two phases, supplied separately with electrical energy, of the phases of the starting winding with a three-phase supply, a second switch which is configured to produce and/or to disconnect an electrical connection between in each case two phases, supplied separately with electrical energy, of the phases of the running winding with a three-phase supply, and a control device which is configured to generate in each case a switch signal for the switches. If instead of a change-over switch, two switches are used which are able to connect respectively one of the windings to the three-phase supply, it is possible for both windings of the three-phase induction machine to be supplied simultaneously with current. If both windings of the three-phase induction machine are powered simultaneously, the three-phase induction machine generates a higher mechanical output power. Alternatively, both windings of the three-phase induction machine can also be connected without current and thus the three-phase induction machine can be disconnected without requiring a further switch.

According to a further possible embodiment, the winding change-over switch permanently connects to the three-phase supply an electrical supply line for one phase of the starting winding and for one phase of the running winding, which are powered by a common electrical supply line. If the winding change-over switch does not provide a facility for disconnecting the electrical supply line which supplies the jointly supplied phases of the starting winding and the running winding, it is possible for double-pole switches to be used in each case for the remaining phases of the running winding and the starting winding. This allows the winding change-over switch to be constructed in a simple manner.

According to a further possible embodiment, the winding change-over switch connects an electrical supply line for one phase of the starting winding and for one phase of the running winding which are powered by a common electrical connection line, to the three-phase supply or the winding change-over switch disconnects this electrical connection line from the three-phase supply, based on the switch signals from the control device. If a means is provided which is configured to disconnect the supply line powering the phases, electrically connected in the three-phase induction machine, of the running winding and starting winding, the entire three-phase induction machine can be connected without current. This is particularly advantageous when maintenance work is carried out on the three-phase induction machine. It is thus possible to dispense with a dedicated switch for disconnecting the phase of the starting winding and the phase of the running winding which are powered by a common electrical connection line.

According to a further possible embodiment, a neutral point of the starting winding and a neutral point of the running winding are electrically insulated from one another. If the neutral points of the starting winding and of the running winding are electrically insulated from one another, current cannot flow between the two windings, even if respectively one of the phases of the two windings is supplied with electrical energy by a common electrical supply line.

According to a further possible embodiment, the control device is configured as a discrete circuit, as a microprocessor, as an application-specific integrated circuit (ASIC) and/or as a combination of the mentioned possibilities. The flexibility in the configuration of the control device is thus enhanced and the solution most suitable for the respective case of use can be implemented.

According to a further possible embodiment, generating at least one switch signal comprises the step of generating a change-over signal which causes the supply of the starting winding with electrical energy in the start-up phase of the three-phase induction machine; and/or which causes the supply of the running winding with electrical energy at the end of the start-up phase of the three-phase induction machine. If only a single switch signal is generated for an individual change-over switch, it is possible to provide a simple control device, the wiring of which is not complex.

According to a further possible embodiment, generating at least one switch signal comprises the step of generating a first switch signal which causes the supply of the starting winding with electrical energy, and/or of generating a second switch signal which causes the supply of electrical energy to the running winding, the first signal and the second signal being generated in a time-delayed manner. If in each case an individual switch signal is generated for a switch which supplies the starting winding with electrical energy, and for a switch which supplies the running winding with electrical energy, the flexibility of the three-phase induction machine is enhanced. It is possible for both the starting winding and the running winding to be supplied with electrical energy to generate a higher mechanical power by the three-phase induction machine, or it is possible for both the starting winding and the running winding to be connected without current in order to disconnect the three-phase induction machine. A further switch for disconnecting the three-phase induction machine is not required.

According to a further possible embodiment, to generate at least one switch signal, an external control signal is received and the switch signal is generated from the external control signal. If the three-phase induction machine is configured to receive control signals from external signal sources, it can be easily integrated into available electromechanical installations.

According to a further preferred development, supplying the starting winding with electrical energy and/or supplying the running winding with electrical energy comprises the step of supplying with electrical energy the phases, supplied with electrical energy in each case by a separate electrical supply line, of the starting winding, or supplying with electrical energy the phases, supplied with electrical energy in each case by a separate electrical supply line, of the running winding by means of a change-over switch, subject to the at least one switch signal from the control device. If only two of the electrical supply lines of the starting winding and of the running winding of a three-phase induction machine can be operated by a change-over switch, this change-over switch can be configured in a particularly simple manner. It is possible to provide only one switch element due to the use of a change-over switch.

According to a further preferred development, supplying the starting winding with electrical energy and/or supplying the running winding with electrical energy comprises the following steps, namely supplying with electrical energy the phases, supplied with electrical energy in each case by a separate electrical supply line, of the starting winding, by means of a first switch subject to the first switch signal from the control device and/or supplying with electrical energy the phases, supplied with electrical energy in each case by a separate electrical supply line, of the running winding, by means of a second switch subject to the second switch signal from the control device. If a single switch is used in each case to supply the starting winding and/or the running winding of the three-phase induction machine with electrical energy, the flexibility of the three-phase induction machine is enhanced. Consequently, both the starting winding and the running winding can be supplied simultaneously with electrical energy or neither the starting winding nor the running winding can be supplied with electrical energy.

### BRIEF DESCRIPTION OF THE DRAWINGS

In the following, the invention will be described in more detail on the basis of embodiments with reference to the accompanying figures, in which:

FIG. 1 is a schematic illustration of an embodiment of a three-phase induction machine according to the invention;

FIG. 2 is a flow chart of an embodiment of a method according to the invention for operating a three-phase induction machine;

FIG. 3 is a schematic illustration of an aircraft with an embodiment of a three-phase induction machine according to the invention;

FIG. 4 is a schematic illustration of a possible embodiment of a three-phase induction machine according to the invention;

FIG. 5 is a schematic illustration of a further possible embodiment of a three-phase induction machine according to the invention;

FIG. 6 is a schematic illustration of a further possible embodiment of a three-phase induction machine according to the invention; and

FIG. 7 is a schematic illustration of a conventional three-phase induction machine.

In the figures, the same reference numerals denote identical or functionally identical components, unless indicated otherwise.

### DETAILED DESCRIPTION OF THE PREFERRED EMBODIMENTS

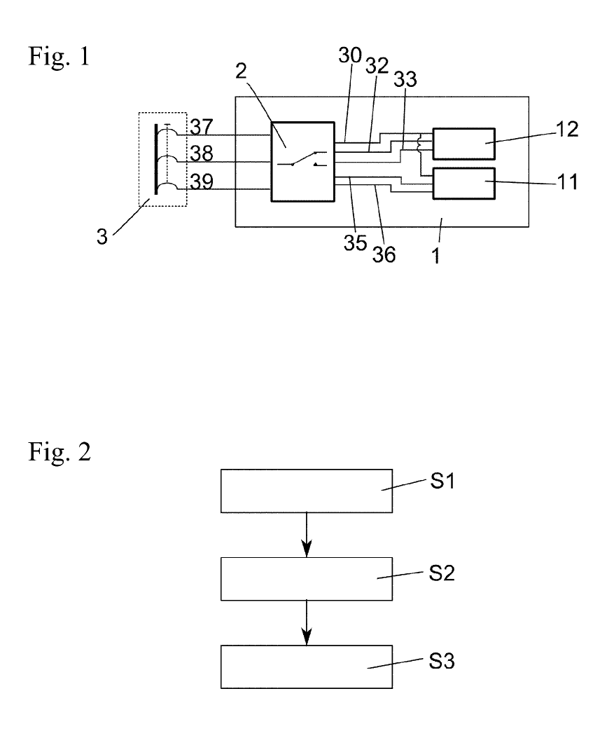

FIG. 1 is a schematic illustration of an embodiment of a three-phase induction machine 1 according to the invention. The three-phase induction machine 1 has a starting winding 11, a running winding 12 and a winding change-over switch 2. The starting winding 11 is coupled with the winding change-over switch 2 by the electrical connection lines 30, 35, 36 and the running winding 12 is coupled with the winding change-over switch 2 by the electrical connection lines 30, 32, 33. FIG. 1 also shows a three-phase supply 3 which is connected to the winding change-over switch 2 by the electrical connection lines 37, 38, 39.

To start up the three-phase induction machine 1 after being at a standstill, the winding change-over switch 2 creates an electrical connection between the three-phase supply 3 and the starting winding 11. As soon as the three-phase induction machine 1 has reached its nominal speed, the winding change-over switch 2 interrupts the electrical supply to the starting winding 11 and creates an electrical connection between the three-phase supply 3 and the running winding 12. The three-phase induction machine 1 only achieves a relatively low mechanical power by means of the starting winding 11. Only after the running winding 12 has been supplied with electrical energy does the three-phase induction machine 1 reach its predetermined nominal power.

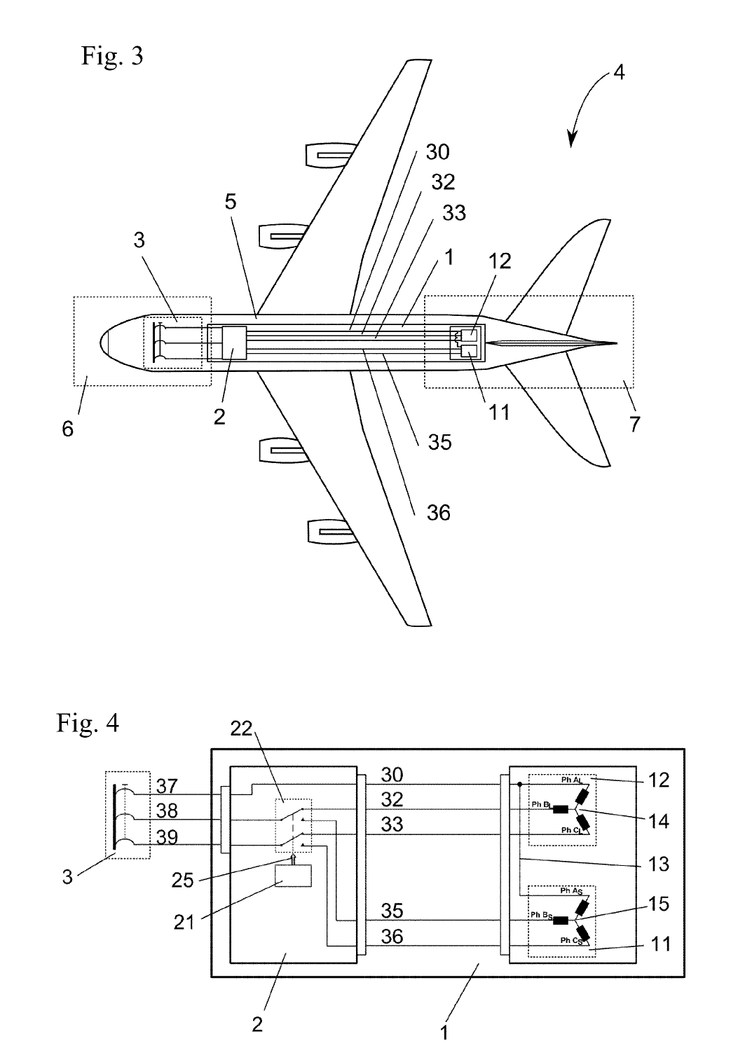

In an exemplary embodiment, the three-phase induction machine 1 is provided in an aircraft 4, as shown in FIG. 3, and is configured for a three-phase supply 3 with a nominal voltage of 115 volts at a frequency of 400 Hertz. In a further exemplary embodiment, the three-phase induction machine 1 can be configured for operation with a three-phase supply 3 of a nominal voltage in the region of up to 600 volts. The frequency of the three-phase supply 3 can assume a value within a range of 100 Hz to 1000 Hz. In possible embodiments, the three-phase induction machine 1 has a mechanical power of up to 500 kW.

In further embodiments, the three-phase induction machine 1 is configured with a mechanical power in the region of up to 5 MW to drive conveyors, compressors or further components in industrial plants.

If the three-phase induction machine 1 starts without a load, it has a lower power consumption during the start-up procedure compared to running operation. The conductors of the supply line of the starting winding 11 can thus be provided with a smaller cross section than the conductors of the supply line of the running winding 12. The resistance/impedance thereof must be substantially lower due to the higher power consumption to prevent a high voltage drop via the supply line. In a possible embodiment of the three-phase induction machine 1, the specific resistance of each conductor of the supply line of the running winding 12 is 0.97 Ohm/km (for a supply line with a conductor cross section of approximately 22 mm2) and the specific resistance of the conductors of the supply line to the associated starting winding 11 is 2.3 Ohm/km (for a supply line with a conductor cross section of approximately 9 mm2). In further embodiments, the specific resistance of the conductors of the supply line to the running winding 12 can assume a value within a range of from 0.5 Ohm/km to 50 Ohm/km, subject to the length of the line and the power to be transmitted, and the specific resistance of the conductors of the supply line to the starting winding 11 can have a value within a range of from approximately 1 Ohm/km to 100 Ohm/km.

FIG. 2 is a flow chart of an embodiment of a method according to the invention for operating a three-phase induction machine 1.

In a first step S1, a phase Ph AS of the starting winding 11 and a phase Ph AL of the running winding 12 of the three-phase induction machine 1, as shown in FIGS. 4, 5, 6, are each supplied with electrical energy by a common electrical supply line 30.

In a second step S2, a control device 21, as shown in FIGS. 4, 5, 6, generates at least one of the switch control signals 25, 25-1, 25-2, which are also shown in FIGS. 4, 5, 6, for at least one of the switches 22, 23, 24. In this respect, the switch signal preferably has information concerning which of the two windings 11, 12 of the three-phase induction machine 1, i.e. the starting winding 11 or the running winding 12, is to be supplied with electrical energy.

In a third step S3, one of the two windings 11, 12 of the three-phase induction machine 1, i.e. the starting winding 11 or the running winding 12, is supplied with electrical energy. For this, the control device 21 transmits the at least one switch control signal 25, 25-1, 25-2 to at least one of the switches 22, 23, 24. Subject to the switch control signals 25, 25-1, 25-2 which have been received, the switches 22, 23, 24 close and/or open an electrical connection of the starting winding 11 and/or of the running winding 12 with the three-phase supply 3.

FIG. 3 is a schematic illustration of an aircraft 4 which has a three-phase induction machine 1 according to the invention.

FIG. 3 shows an aircraft 4 with an aircraft fuselage 5. Also provided in the aircraft 4 are at least one three-phase induction machine 1 and an associated three-phase supply 3. In this respect, in the illustrated embodiment the starting winding 11 and the running winding 12 of the three-phase induction machine 1 are provided in a tail region 7 and the three-phase supply 3 and the winding change-over switch 2 of the three-phase induction machine 1 are provided in a front region 6 of the aircraft 4. The winding change-over switch 2 is connected to the starting winding 11 and to the running winding 12 by five electrical supply lines 30, 32, 33, 35, 36. In a conventional aircraft, six electrical supply lines would be required here.

For technical reasons, it may be necessary to provide the winding change-over switch 2 at a distance from a starting winding 11 which is positioned in a tail region 7 of the aircraft 4 and from a running winding 12 which is positioned in the tail region 7 of the aircraft 4. Depending on the mechanical power of the three-phase induction machine 1, a considerable electrical power has to be transmitted from the winding change-over switch 2 to the starting winding 11 and to the running winding 12. The conductors of the electrical supply lines which are used for a three-phase induction machine 1 of this type in an aircraft 4 can weigh up to 500 grams per metre depending on the length of the line and on the power to be transmitted (or on the cross section of the conductor). It can be seen in FIG. 3 that in the arrangement according to the invention, an electrical supply line can be omitted between the winding change-over switch 2 and the starting winding 11 and/or the running winding 12 in an aircraft 4 which can have a fuselage length of more than 70 metres. This implies a significant reduction in weight.

In an exemplary embodiment, the three-phase induction machine 1 can drive a compressor of an air conditioning system for the cabin of the aircraft 4. In further embodiments, the three-phase induction machine 1 can also be configured to drive an electric hydraulic pump, a hold door, a valve or the like of the aircraft 4.

FIG. 4 is a schematic illustration of a preferred embodiment of a three-phase induction machine 1 according to the invention.

In this respect, FIG. 4 shows a three-phase induction machine 1 with a starting winding 11 and a running winding 12. Phase A Ph AS of the starting winding 11 is electrically connected to phase A Ph AL of the running winding 12 by an electrically conductive connection 13. The three phases Ph AS, Ph BS, Ph CS of the starting winding 11 are electrically interconnected at a common neutral point 15 and the three phases Ph AL, Ph BL, Ph CL of the running winding 12 are electrically interconnected at a common neutral point 14. Furthermore, the two electrically connected phases Ph AS, Ph AL of the starting winding 11 and of the running winding 12 are connected to the winding change-over switch 2 by a common supply line 30. The further phases Ph BS, Ph CS of the starting winding 11 and the further phases Ph BL, Ph CL of the running winding 12 are connected to the winding change-over switch 2 by lines 32, 33, 35, 36. Provided in the winding change-over switch 2 are a control device 21 which generates a switch control signal 25 for a change-over switch 22, and the change-over switch 22. The change-over switch 22 in FIG. 4 has two inputs and four outputs and can thus switch over in each case the connection between two phases Ph BS, Ph BL and Ph CS, Ph CL and the three-phase supply 3. The supply line 30 which feeds the electrically connected phases Ph AS, Ph AL is guided in the winding change-over switch 2 directly from the input of the winding change-over switch 2 to the output of the winding change-over switch 2. Finally, the winding change-over switch 2 is connected to a three-phase supply 3 by the lines 37, 38 and 39.

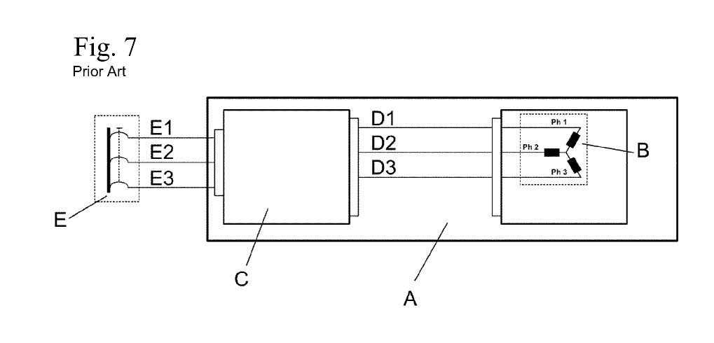

The embodiment, shown in FIG. 4, of a three-phase induction machine 1 according to the invention affords the possibility of starting up the three-phase induction machine 1 with a reduced starting current in the start-up phase. Compared to a known three-phase induction machine A, as illustrated in FIG. 7, the embodiment illustrated in FIG. 4 also affords the advantage of dispensing with one electrical supply line. Furthermore, in this embodiment, the change-over switch 22 can be of a simpler configuration because it only has to switch over two electrical lines, instead of the usual three.

In an exemplary embodiment, the change-over switch 22 can be implemented by a contactor or by a contactor switch. In an embodiment of this type, the control device 21 generates a switch control signal 25 during the start-up phase of the three-phase induction machine 1 and this switch control signal 25 causes the contactor switch 22 to electrically connect the supply voltage of the lines 38 and 39 to the supply lines 35 and 36 of phases Ph BS, Ph CS of the starting winding 11 of the three-phase induction machine 1. When the three-phase induction machine 1 has reached its nominal speed, the control device 21 generates a switch control signal 25 which causes the contactor switch 22 to electrically connect the supply voltage of the lines 38 and 39 to the supply lines 32 and 33 of phases Ph BL, Ph CL of the running winding 12 of the three-phase induction machine 1.

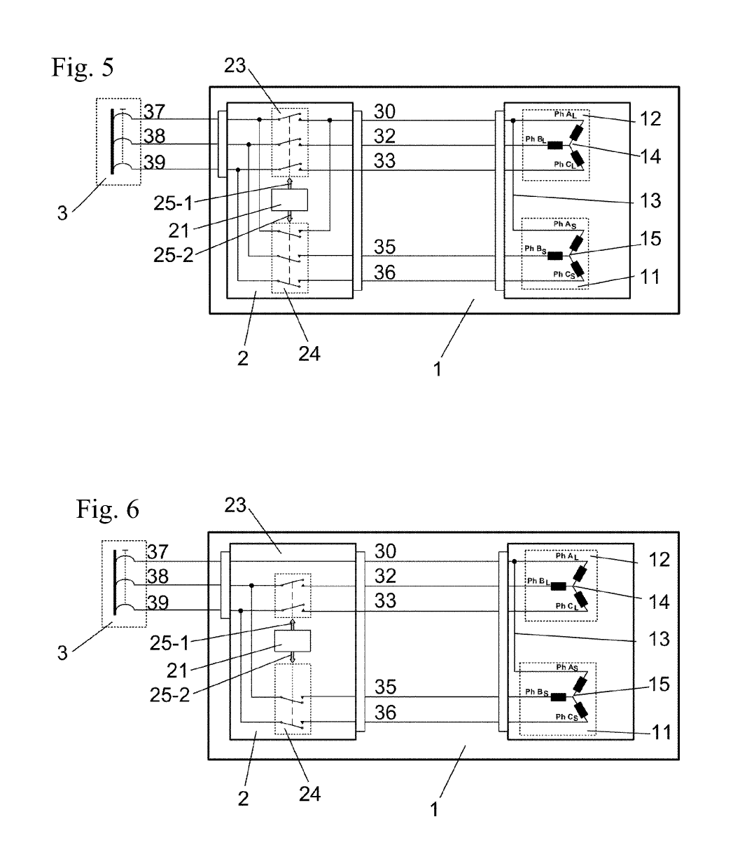

FIG. 5 is a schematic illustration of a further preferred embodiment of a three-phase induction machine 1 according to the invention.

In FIG. 5, the construction of the three-phase induction machine 1 corresponds very closely to the construction of the three-phase induction machine 1 of FIG. 4. In contrast to FIG. 4, the winding changeover switch 2 in FIG. 5 has a control device 21 which generates two switch control signals 25-1, 25-2 for two switches 23 and 24. The switches 23 and 24 each have three inputs which are connected to a three-phase supply 3 by the lines 37, 38 and 39. The three outputs of the first switch 23 are connected to the lines 30, 32 and 33 and thus supply the three phases Ph AL, Ph BL, Ph CL of the running winding 12. Furthermore, the first electrical supply line of the second switch 24 is connected to the first output of the first switch 23. The two further outputs of the second switch 24 are connected in each case to the electrical supply lines 35, 36. Consequently, the second switch 24 supplies with electrical energy the three phases Ph AS, Ph BS, Ph CS of the starting winding 11 by the electrical supply line 30 which is also used for phase A Ph AL of the running winding 12 and by the electrical supply lines 35, 36.

The embodiment illustrated in FIG. 5 also affords the advantage that one electrical supply line is omitted. In the embodiment illustrated in FIG. 5, it is also possible to connect both windings 11, 12, i.e. the starting winding 11 and the running winding 12, of the three-phase induction machine 1 without current. For this purpose, the control device 21 generates switch control signals 25-1, 25-2 which cause the switches 23 and 24 to disconnect the electrical supply lines 30, 32, 33, 35, 36 from the three-phase supply 3. This is particularly advantageous when maintenance work has to be carried out on the three-phase induction machine 1 or on other components of the installation.

FIG. 6 is a schematic illustration of a further embodiment of a three-phase induction machine 1 according to the invention.

The three-phase induction machine 1 illustrated in FIG. 6 corresponds to the three-phase induction machine 1 illustrated in FIG. 5, except for the winding change-over switch 2. Unlike the three-phase induction machine 1 illustrated in FIG. 5, the switches 23, 24 of the three-phase induction machine 1 illustrated in FIG. 6 each have only two inputs and the electrical supply line 37 of the three-phase supply 3 is permanently connected to the electrical supply line 30 of phase A Ph AS of the starting winding 11 and to phase A Ph AL of the running winding 12. In this embodiment, the two switches 23, 24 can be configured in a particularly simple manner, more specifically as double-pole switches 23, 24.

Although the present invention has been described above with reference to preferred embodiments, it is not restricted thereto, but can be modified in many different ways.

In a further possible embodiment, for example two phases other than phase A Ph AS of the starting winding 11 and phase A Ph AL of the running winding 12 of the three-phase induction machine 1 can also be electrically interconnected in each case in the three-phase induction machine 1. In such a case, the supply line 30 would be switched over by the contactor switch 22 and one of the further supply lines, for example supply line 32 would be guided directly from the input of the winding change-over switch 2 to an output of the winding change-over switch 2, if phase B Ph BS of the starting winding 11 and phase B Ph BL of the running winding 12 of the three-phase induction machine 1 were electrically interconnected in the three-phase induction machine 1. In a further possible embodiment, the change-over switch 22 is not implemented by a contactor switch, but by at least one relay or by at least one semiconductor relay.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-14. (canceled)

15. A three-phase induction machine, comprising:
a starting winding and a running winding;
and comprising:
a winding change-over switch which switches over a flow of current between the starting winding and the running winding;
wherein a phase of the phases of the starting winding and a corresponding phase of the phases of the running winding of the three-phase induction machine are supplied with electrical energy by a common electrical supply line; and
wherein one phase of the phases of the starting winding and the corresponding phase of the phases of the running winding are interconnected by an electrically conductive connection in the three-phase induction machine

16. The three-phase induction machine according to claim 15, wherein the winding change-over switch has a change-over switch which is configured to switch over, with a three-phase supply, a connection between in each case two phases, supplied separately with electrical energy, of the phases of the starting winding and the two respectively corresponding phases, supplied separately with electrical energy, of the phases of the running winding; and
wherein the winding change-over switch comprises a control device which is configured to generate a switch control signal for the change-over switch;
wherein the winding change-over switch permanently connects to the three-phase supply an electrical supply line for the electrically interconnected phases of the starting winding and of the running winding.

17. The three-phase induction machine according to claim 15, wherein the winding change-over switch comprises a first switch which is configured to at least one of produce and disconnect a connection between in each case two phases, supplied separately with electrical energy, of the phases of the starting winding with a three-phase supply; and
wherein the winding change-over switch comprises a second switch which is configured to at least one of produce and disconnect a connection between in each case two phases, supplied separately with electrical energy, of the phases of the running winding with a three-phase supply; and
wherein the winding change-over switch comprises a control device which is configured to generate in each case a switch control signal for the switches.

18. The three-phase induction machine according to claim 17, wherein the winding change-over switch permanently connects to the three-phase supply an electrical supply line for one phase of the starting winding and one phase of the running winding which are supplied by a common electrical supply line.

19. The three-phase induction machine according to claim 17, wherein the winding change-over switch at least one of closes and disconnects an electrical connection of the electrical supply line for one phase of the starting winding and for one phase of the running winding which are supplied by a common electrical supply line, with the three-phase supply, based on the switch control signals of the control device.

20. The three-phase induction machine according to claim 15, wherein a neutral point of the starting winding and a neutral point of the running winding are electrically insulated from one another.

21. The three-phase induction machine according to claim 15, wherein the control device is configured as a discrete circuit, as a microprocessor, as an application-specific integrated circuit and/or as a combination of the mentioned possibilities.

22. A method for operating a three-phase induction machine, in particular a three-phase induction machine according to claim 15, comprising the steps:
supplying a phase of a starting winding and a corresponding phase of a running winding of the three-phase induction machine with electrical energy by a common electrical supply line,
generating at least one switch control signal by a control device depending on whether the starting winding or the running winding of the three-phase induction machine is to be supplied with electrical energy,
supplying at least one of the starting winding with electrical energy and the running winding with electrical energy, subject to the at least one switch control signal generated by the control device.

23. The method according to claim 22, wherein the step for generating at least one switch control signal comprises a sub-step of generating a change-over signal which causes at least one of the supply of the starting winding with electrical energy in the start-up phase of the three-phase induction machine and the supply of the running winding with electrical energy at the end of the start-up phase of the three-phase induction machine.

24. The method according to claim 22, wherein the step for generating at least one switch control signal comprises a sub-step of at least one of generating a first switch control signal which causes the supply of the starting winding with electrical energy and generating a second switch control signal which causes the supply of the running winding with electrical energy;
wherein the first switch control signal and the second switch control signal are generated in a time-delayed manner.

25. The method according to claim 22, wherein for generating the at least one switch control signal, an external control signal is received and the switch control signal is generated from the external control signal.

26. The method according to claim 22, wherein the step for supplying at least one of the starting winding with electrical energy and the running winding with electrical energy comprises a sub-step of supplying with electrical energy the phases, supplied with electrical energy in each case by a separate electrical supply line, of one of the starting winding and the running winding, by means of a change-over switch subject to the at least one switch control signal of the control device.

27. The method according to claim 22, wherein the step for supplying at least one of the starting winding with electrical energy and the running winding with electrical energy comprises at least one of the sub-steps of supplying with electrical energy the phases, supplied with electrical energy in each case by a separate electrical supply line, of the starting winding by means of a first switch subject to the first switch signal of the control device; and supplying with electrical energy the phases, supplied with electrical energy in each case by a separate electrical supply line, of the running winding by means of a second switch subject to the second switch signal of the control device.

28. An aircraft or spacecraft, having a three-phase induction machine according to claim 15, and having a three-phase supply.
